(19) United States
(12) Patent Application Publication
(10) Pub. No.: US 2009/0133027 A1
(43) Pub. Date: May 21, 2009

(54) Systems and Methods for Project Management Task Prioritization

(76) Inventors: Mark B. Gunning, Austin, TX (US); Jason E. Kelley, Austin, TX (US); Nefaur R. Khandker, Burke, VA (US); Ivan S. Kornienko, Old Bridge, NJ (US); Patrick R. Richer, Houston, TX (US); Jeffrey C. Sneden, Austin, TX (US); Kenneth Stephen, Round Rock, TX (US)

Correspondence Address: The Brevetto Law Group, PLLC, 838 Maine Street, Quincy, IL, 62301, US

(21) Appl. No.: 11/943,626

(22) Filed: Nov. 21, 2007

(51) Int. Cl. G06F 9/46

(52) U.S. Cl. 718/103

(57) ABSTRACT

A project management task prioritization system is provided to refine the prioritization factors for tasks in a project based on changes to the order of performing the tasks. The initial proposed order for performing the tasks is provided by the system to the person responsible for the task in a graphical format that allows the person to drag and drop the tasks, adjusting the order of the tasks to their preferred order. A neural network comparator is used to compare the task prioritization factors associated with each pair of tasks that are altered in order to determine a relative priority. The neural network system updates the task prioritization factors based on the changes in order the tasks are to be performed.

### BACKGROUND

1. Field

The present invention relates to the field of project management, and more specifically, to systems, methods and computer programs for prioritizing the tasks in a project.

2. Background

The prosperity of companies and organizations often depends upon how efficiently they can complete large scale projects. Such projects may include the construction of buildings and public works projects, creating and debugging a computer software application, conducting a research project, fabricating a satellite, or a myriad other such endeavors. Companies continually strive to improve their performance through the application of project management techniques to more efficiently manage the firm's resources, including for example, capital resources, human resources, and the time needed to complete the project. Conventional project management software includes tools for project planning, scheduling, developing a product, managing financial and capital resources and monitoring progress.

Conventional project management software provides little insight into the process of prioritizing the tasks to be completed on the project by the project team members. Conventional project management systems have no mechanism for adapting to the considerations of individual team members as they schedule and prioritize the tasks of the project. Conventional project management tools generally rely upon factors such as workflow to specify individual tasks as they relate to others. This, in turn, is used for task prioritization, along with due dates and a limited set of sizing values. Such conventional techniques fail to accurately predict whether one task is more important than another.

What is needed is a project management system capable of factoring in the prioritization considerations of individual team members as they adjust the scheduling of their tasks.

### SUMMARY

Embodiments disclosed herein address the above stated needs by providing a project management task prioritization system including embodiments drawn to systems, methods and computer products for determining prioritization factors for tasks in a project. An initial list showing the order of the tasks in the project is provided to a user who may be the employee assigned to perform the tasks. The initial order of the tasks may be provided in a graphical format with objects representing each of the tasks so that the user can drag and drop the tasks into the order that they will be performed in. The project management task prioritization system detects the task order adjustments made by the user. The system calculates the relative priority of the affected tasks based on the user's adjustments to the task order. This information can then be used to refine the prioritization factors for the tasks affected by the task order adjustments made by the user.

In some embodiments a neural network system is used to compare the relative prioritization of the tasks affected by the user adjustments. Prioritization factors that are common to the tasks being compared are used to compare each pair of tasks affected by the adjustment in order to determine the relative priority of the tasks.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts a functional overview of various activities and systems for project management task prioritization;

FIG. 2 depicts an overview of data flow in an exemplary project management task prioritization system;

FIG. 3 depicts a block diagram of an exemplary neural network system suitable for use with various embodiments of a project management task prioritization system;

FIGS. 4A-B depict a task order adjustment being made by a user, and the comparator outputs from an exemplary neural network resulting from a shift in task prioritization;

FIG. 5 is a flowchart depicting activities in an exemplary method for project management task prioritization; and

FIG. 6 depicts an exemplary computer network and a block diagram of an information handling system suitable for implementing various embodiments of a project management task prioritization system.

### DETAILED DESCRIPTION

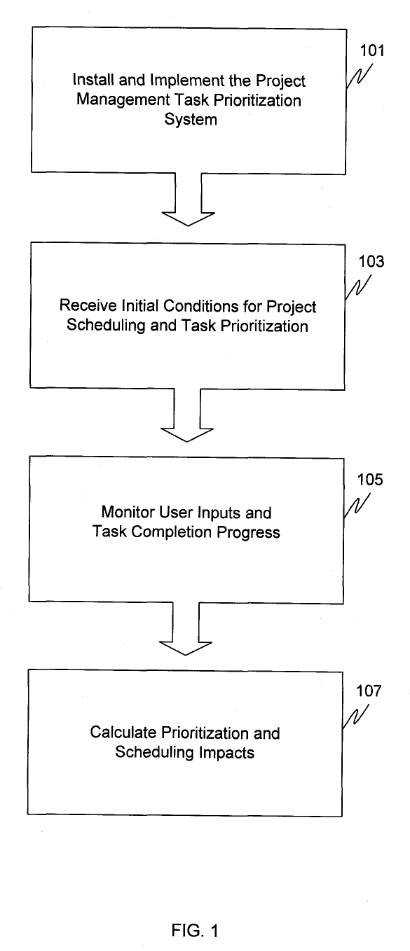

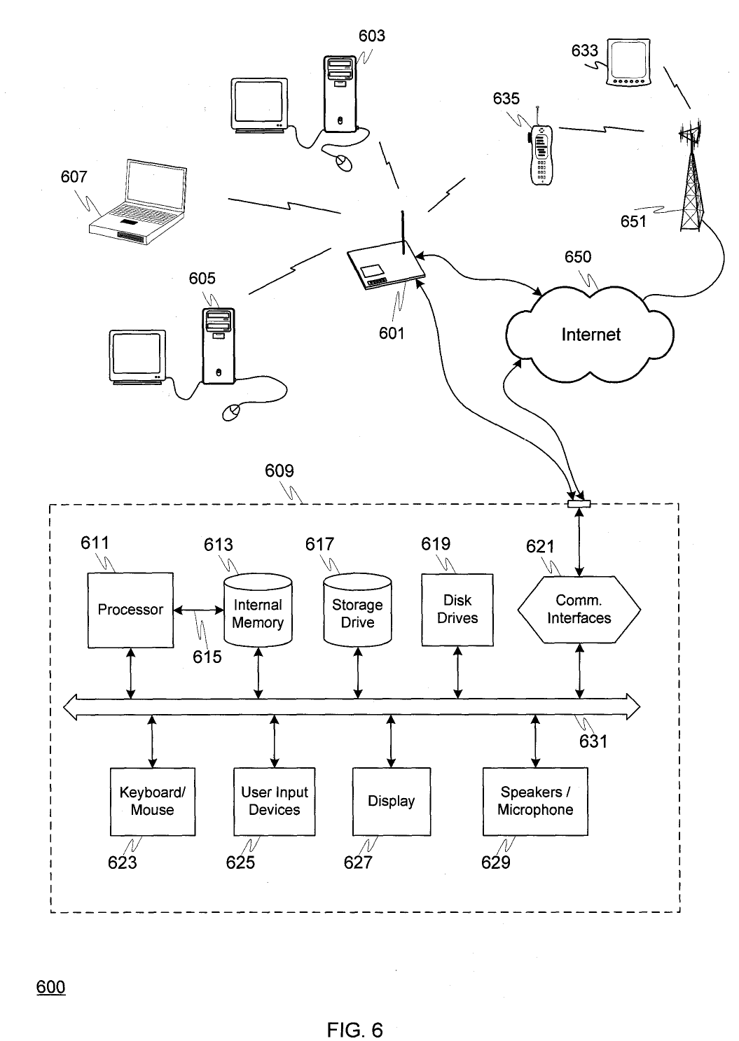

FIG. 1 depicts a top-level functional overview of activities involved in setting up and operating a project management task prioritization system in accordance with various embodiments disclosed herein. The first activity of FIG. 1 in 101 involves the installation and implementation of the project management system, which may be embodied, for example, as a computer application for project management task prioritization. In many instances the activities of 101 may include loading and configuring the project management computer application on the company's computer system. Details of a typical computer system suitable for use with a project management computer application are shown in FIG. 6. Companies often have a computer network such as a local area network (LAN) in place for its employees to use for business purposes. Implementing the project management computer application may entail providing access to it for the company's employees via the company's network, if any. Once the project management application is installed and implemented in 101 the method proceeds to 103.

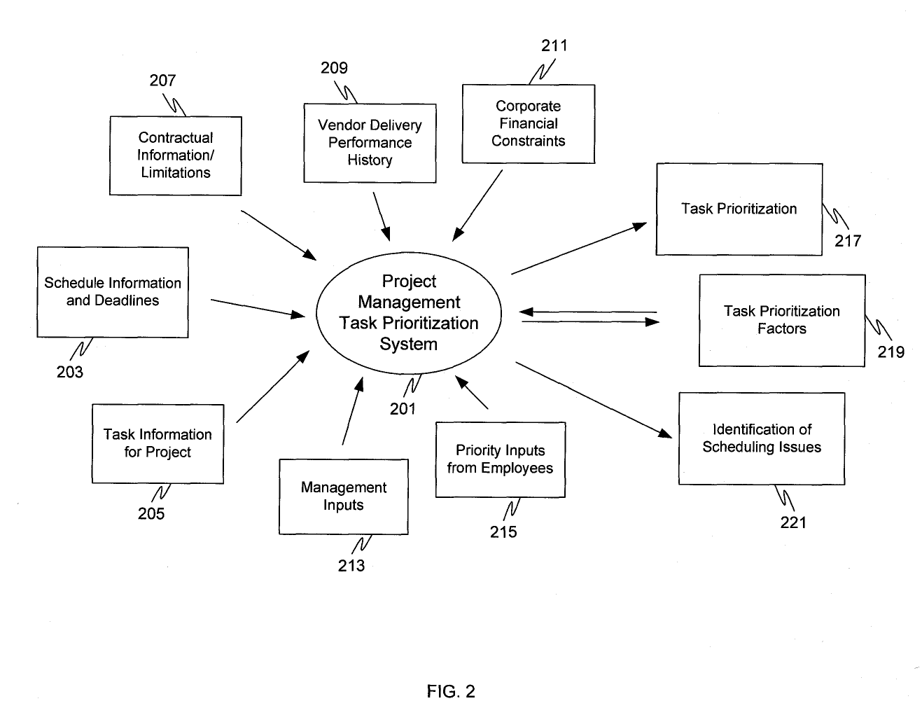

In 103 the initial conditions for a project are received or otherwise entered into the project management computer application. The initial conditions of the overall project will typically include things such as the final due date for the project, the specifications or other requirements for the product or service produced by the project, and contractual provisions that may affect the performance of the project tasks. The activities of 103 may also include the creation of a list of tasks to be completed for the project, and the assignment of these tasks to the individuals/teams that will be completing them. These sorts of information may be provided by a project manager, project planners, or others within the company responsible for management of the project. In addition, an estimate of the time required for each task, a list of tasks that are dependent on other tasks being completed first (task dependency), and an initial task prioritization listing may be produced at this time. A further discussion is provided in conjunction with FIG. 2 for the various information processed by the project management computer application, including the initial conditions for the project. Once the initial conditions for a project have been completed in 103 the method proceeds to 105.

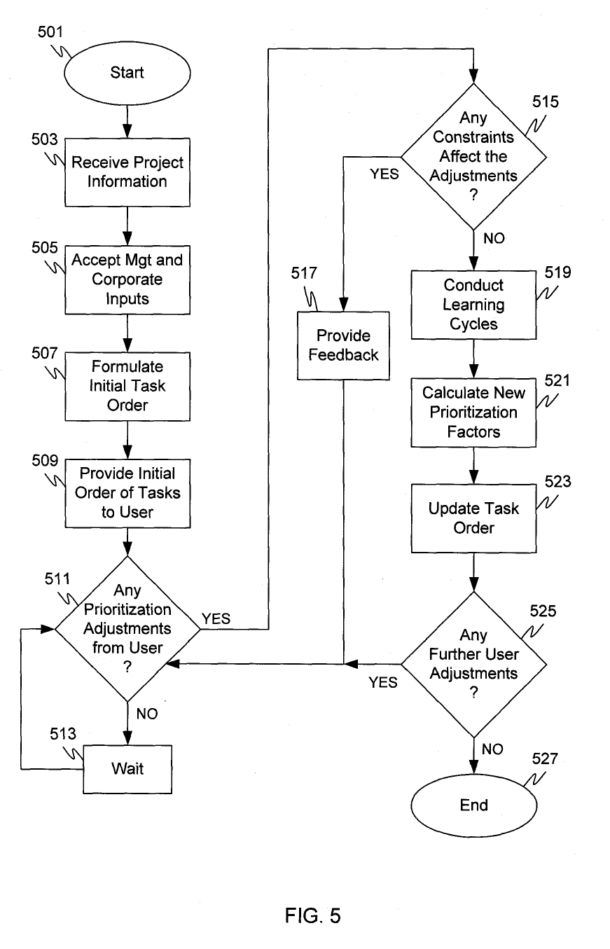

The activities of 105 include monitoring the user inputs regarding task prioritization and keeping track of status concerning the completion of the various tasks. The project management system typically provides a list of the tasks to be performed to the employee assigned to perform them (e.g., the user). The listing may be provided in a graphical user interface (GUI) format that allows the employee to manipulate the tasks by selecting and dragging them. The employee may be expected to enter progress reports for the various tasks they have been assigned to complete. In addition, the employee may be expected to revise the initial settings of task prioritization to reflect the order in which the employee plans to complete their tasks. This may be done, for example, by dragging and dropping tasks within the task list of the GUI interface into the order desired by the employee. As the employee adjusts the order in which they plan to complete their tasks, the project management computer application monitors the user inputs, as they pertain to task prioritization. A more detailed discussion of activities involving the monitoring of user inputs and project management task prioritization is provided in conjunction with FIG. 5.

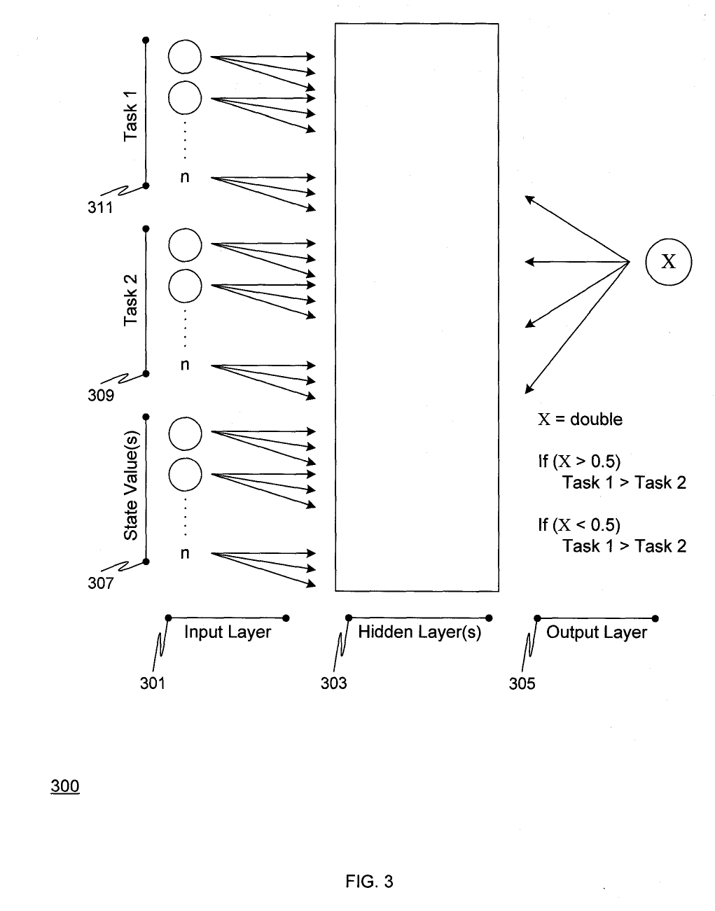

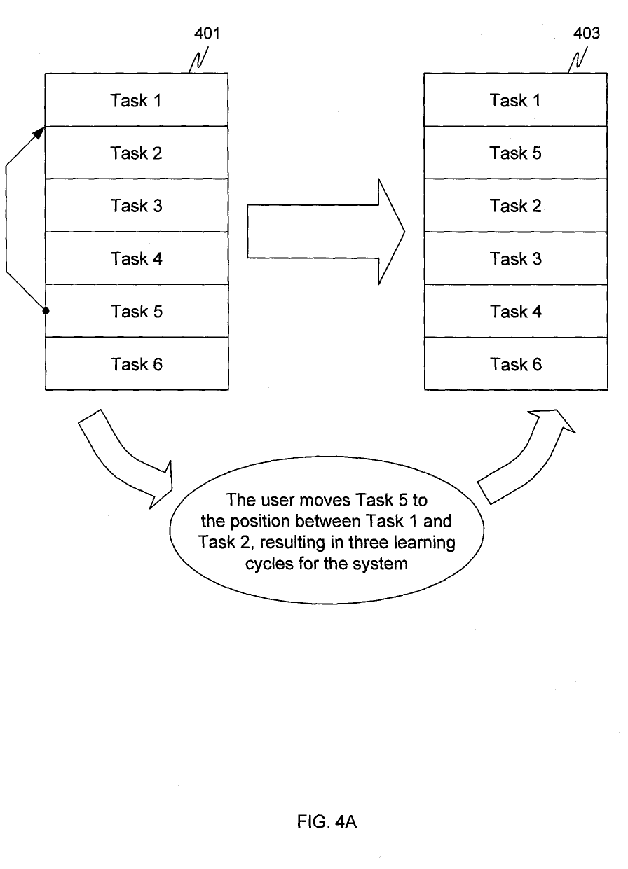

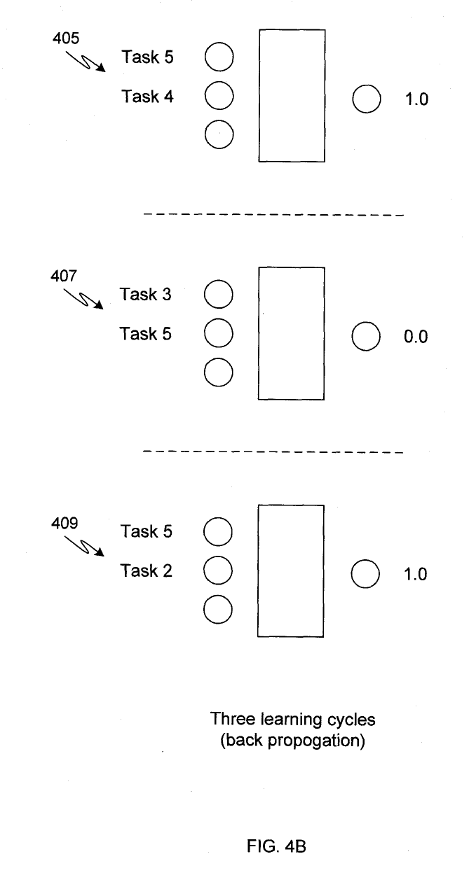

In response to monitoring the employee's inputs regarding task prioritization in 105, the project management system may make adjustments to its task prioritization algorithms in 107. For example, the employee may alter the order in which their assigned tasks are to be completed. This can be taken by the system as an indication that the employee has a different prioritization than the proposed initial prioritization provided by the project management system. In response, the system may use these inputs from the employee to update the prioritization values associated with the tasks of the project. In some embodiments the project management computer application may use neural network methods to update the task prioritization values. An exemplary neural network system of the type suitable to implement the various embodiments is depicted in FIG. 3, and a discussion of neural network calculations is provided in conjunction with FIGS. 4A-B.

FIG. 2 depicts an overview of data flow in an exemplary project management task prioritization system. The project management task prioritization system allows for the adaptation of task order to individual users. However, while an employee might have an understanding of how to deal with their assigned tasks efficiently, the employee may lack the vision to understand which factors are more important for the business. This is why the managerial input and other information are also considered when it comes to prioritizing employees tasks. Moreover, by using a neural net, the project management task prioritization system can learn from the employees' inputs to develop a model for task prioritization. FIG. 2 shows various information inputs used in the task prioritization model, as well as outputs of the system.

The focal point for flow of information is the project management task prioritization system 201. The information and data exchanged includes inputs from the employees performing the tasks as well as inputs relating to the project from various groups within the company, and in particular, the manager(s) responsible for overseeing the project. The employees making decisions to prioritize their own tasks may consider many factors in addition to the ultimate due date of the project. For example, individual team members may take into consideration their own skill level, familiarity with the tasks, work preferences, compatibility with other team members involved, or other like considerations. Due to the many individual considerations of each employee, it has been very difficult for conventional systems to specify which factors need to be considered.

The project schedules and deadlines 203 are an important part of the information received and processed by the project management task prioritization system 201. The project schedules and deadlines 203 information may come from the customer purchasing the project, from a contractual obligation concerning the project, may be a goal of the company's management, or other source of scheduling information. The project may be broken down into smaller project tasks in the task information 205. The task information includes all the various activities involved in completing the project. The contractual information 207 may be derived from a contract between the customer and the company for the project. In addition to financial terms the contractual information 207 may include a specification of the technical requirements for the project.

The management inputs 213 include management-imposed goals or requirements for performing tasks of the project. For example, the company's management may require that certain difficult tasks be started towards the beginning of the project in order to reduce the risk of schedule overruns. The management inputs 213 may include requirements for completing one task early in the project because other tasks cannot be started until its completion. Sometimes a project task cannot be started until a good or service is first received from another company—that is, the outside good or service is a condition precedent to starting the task. Project managers often stipulate that one of the first tasks to be completed is the ordering of the long-lead-time parts required for the project. It is sometimes the case that the time required to receive the long-lead-time parts drives the schedule of the entire project. Companies may track the delivery performance of vendors in 209 in order to know which vendors of outside goods or services have the best track record of meeting their delivery deadlines. Additional information that may be considered includes corporate financial constraints 211 that may be imposed upon the tasks of the project. For example, the management of a company may impose a spending moratorium during a certain quarter to make the company's financial position appear better. This could result in pushing a task out into the next quarter if the task involves large purchases or cash outlays.

In 215 the employees provide their inputs for the prioritization of the tasks they are responsible for. This may be done using a GUI interface of the task prioritization system that allows the employee to manipulate objects representing the tasks by selecting and dragging them into the order the employee plans to work on them. The task prioritization 217 is one of the outputs resulting from the various inputs to the system. Once the employee has inputted their adjustments to the order of tasks, the project management task prioritization system can calculate or adjust the prioritization factors 219 used in developing an initial priority order for the tasks. The project management task prioritization system can also produce an updated schedule 211 that identifies any potential schedule conflicts arising from the various inputs to the system.

FIG. 3 depicts a block diagram of an exemplary neural network system 300 suitable for use with various embodiments of a project management task prioritization system. As a user alters the order of their tasks, the neural network system 300 is able to further define the prioritization factors used in developing an initial task prioritization order. For example, a user may be assigned to complete the six tasks shown in 401 of FIG. 4A in the order from Task 1 to Task 6. However, the user may prefer to perform Task 5 earlier in the order, moving this task up to the position between Task 1 and Task 2, as shown in 403. The neural network system 300 is able to further define its prioritization factors for these tasks based on Task 5 being moved up in the order by the user.

Returning to FIG. 3, the inputs 301 for the neural net typically include a pre-specified list of dimensions. The dimensions are variables that affect or control the scheduling of the project tasks. Dimensions may be anything from dependent tasks, due dates and deadlines, costs, employee skill levels, team preferences, or any other factor that might affect the priority of a given task. Typically, the dimensions are the same for two tasks being compared. If one of the tasks does not have a given dimension (e.g., if one of the prioritization factors is unavailable for one of the two tasks being compared), then the neurons representing that dimension for both tasks may be set to zero. The neural network system 300 further defines its prioritization factors by processing pairs of the tasks affected by the move and outputting the result-a single neuron-based on whether the prioritization factors of one task are greater or smaller than the second task to which it is compared.

FIG. 4A depicts task order adjustments being made by changing the position of Task 5 from the initial task order provided to the user by the project management task prioritization system. FIG. 4B depicts the inputs and outputs of an exemplary neural network comparator. In the example of FIG. 4A, Task 5 is compared to each of the tasks it leapfrogs in moving to its new position. In each comparison, or learning cycle, the neural network system 300 learns about task prioritization from the actions of the user who is adjusting the order of their tasks within their task view. When a user moves a task in relation to other tasks, the number of possible learning cycles is equal to the number of tasks that the moving task is moving past. FIG. 4B depicts three learning cycles, with Task 5 being compared to Task 4 in 405, Task 3 being compared to Task 5 in 407, and Task 5 being compared to Task 2 in 405. In some embodiments the neural network comparator compares the task prioritization factors that one task has in common with another task. In making this comparison, the task prioritization factors may be weighted according to the importance of the task prioritization factors as inputted by the project manager or other decision maker. Task prioritization factors include factors that affect or determine the priority of the project tasks, such as the project due date, schedule milestones, employee skill levels or familiarity with the task, preferences/compatibility of the team members, task precedence (e.g., tasks that must be completed in order to perform other tasks), components with long-lead times, financial constraints, the requirements of other projects that may affect the present project, holiday work schedules, overtime considerations, or any other like types of considerations or factors known to those of ordinary skill in the art that may have an impact on the performance of the project or the user's perception of task prioritization. The task prioritization factors are typically used as dimensions for the neural network comparator.

As the user makes adjustments to the order of the tasks the prioritization of tasks is affected. The neural net 300 of FIG. 3 may be used as a comparator function to inject each task one by one into the list, comparing it to the tasks that already populate the ordered list. For the comparison of each cycle, if the output is greater than 0.5 then the first task is greater than the second, if the value is less than 0.5 then the second task is greater. For the exemplary system depicted, if the value is greater than 0.5, then the first task is greater than the second—that is, the first task is higher priority than the second task—and the output is 1.0. However, if the value is less than 0.5 then the second task is greater (higher priority), and the output is 0.0. In 405, since Task 5 was moved ahead of Task 4, Task 5 is higher priority than Task 4 and the result is 1.0. Similarly, in 409, since Task 5 was moved ahead of Task 2, Task 5 is higher priority than Task 2 and the result is 1.0. However, in 407 the comparison is slightly different, with Task 3 being compared to Task 5. The output in 407 is 0.0 since Task 5 is higher priority than Task 3.

FIG. 5 is a flowchart depicting activities in an exemplary method for project management task prioritization. The method begins in 501 and proceeds to 503 where the project information is received. The project information generally includes the project schedule and deadlines, as well as a description or specification for the project. A listing of some of the tasks may be provided at this time, or may be developed by the management and employees of the company performing the project. Once information of the project has been received in 503 the method proceeds to 505 to gather information and inputs from the company's management, finance department, and other areas of the company that may affect the performance of the project tasks. The information regarding the project often includes inputs about contractual terms, the vendor delivery performance, any corporate financial constraints, or other such considerations that may affect the performance of the project. The information collected in 503 and 505 is described further in conjunction with FIG. 2.

Once the information defining the project and affecting the project's performance has been prepared and gathered together in 503 and 505 the method proceeds to 507 to formulate an initial ordering of the tasks. The initial task order is typically prepared using the project management task prioritization system. The initial task order may incorporate prioritization rules or lessons from past projects of a similar nature learned by the project management task prioritization system. In 509 the initial order of the tasks is provided to the user, that is, the employee assigned to perform the tasks. The initial order may be provided as a feature of the project management task prioritization system that the user has access to. In addition to the initial ordering of tasks, the user may also be given additional information concerning the project such as scheduling and deadline information, specifications/requirements for the user's tasks, and any interface data the user needs to make his portion of the project interoperable with other pieces of the project. For example, if the project is a software development effort and the user is assigned tasks to complete several plug-ins or modules for the software, the user may be provided with the protocols, variable names and any other information needed to make sure that the user's pieces of code work with the rest of the software project. Upon completing 509 and providing the initial task order to the user, the method proceeds to 511.

In 511 it is determined whether the user has made any prioritization adjustments. This may be done by detecting the user changing the initial order of the tasks, for example, by dragging and dropping the tasks into a different order as shown in FIG. 4A. In addition to the task order (describing the order of performing the tasks) the system may show a priority listing to the user showing the system's determination of the task priorities relative to each other. For example, each of the user's tasks may be labeled “High,” “Medium,” or “Low” priority, or may be given an arbitrary priority grade of from 1 to 10, or may be listed in ascending (or descending) order of priority. In such a task priority listing, if provided, the user can adjust the task priorities to reflect the user's opinion as to the task priorities. An adjustment to the order of the tasks (or to the task priority listing) is interpreted by the system in 511 as a prioritization adjustment, and the method proceeds along the “YES” path from 511 to 515. If the system detects that the user has not yet made any prioritization adjustments the method proceeds to 513 to wait for an adjustment, then loops back to 511.

In 515 it is determined whether there are any constraints that affect the adjustment. For example, the user may seek to perform a task later on in the order even though it is needed in another part of the company for their work on the project—that is, the task is a condition precedent to another task. Another constraint may be that the company prefers to push the tasks involving large expenditures out towards the end of the project to improve the financial position of the company for as long as possible. If it is determined in 515 that there are constraints that may possibly prevent the user's proposed adjustments the method proceeds from 515 along the “YES” branch to 517 to provide feedback to the user informing the user of the constraints. The method then proceeds back to 511 to see if the user has any other adjustments to the task prioritization. Back in 515, if it is determined that there are no constraints that would prevent the user's the task prioritization adjustments, the method proceeds along the “NO” branch to 519.

In 519 the neural network system of the project management task prioritization system conducts its learning cycles, comparing the priorities of each task that has been bypassed in the user's adjustment. Further details of this are discussed above in conjunction with FIGS. 4A-B. In the example of FIG. 4A, the user moves Task 5 to the spot following Task 1, leapfrogging Task 4, Task 3 and Task 2. Therefore, the neural network comparator is used to determine the relative priority between Tasks 514, Tasks 5/3 and Tasks 5/2. In the embodiment using neural network, this is done in three learning cycles, as shown in FIG. 4B. In some embodiments, logic other than a neural network may be used to determine the effect on task prioritization due to any task order adjustments made by the user. For example, an algorithm comparing the factors associated with each task, a set of decision rules to apply to any user adjustments, fuzzy logic, or any other like type of analysis means may be used in 519 to determine the effect on task prioritization. Once the neural network or other logic determines the effect on the task prioritization, the method proceeds from 519 to 521.

In 521 the effect on the task prioritization factors due to the user's task order adjustment is incorporated into the project management task prioritization system. In some embodiments this is done by adjusting the weight or application of the factors associated with each task prioritization factor. The task prioritization factors are the factors that affect or determine the priority of the project's tasks, including for example, the due date for the project and any schedule milestones or intermediate dates, skill level of the employees, familiarity with the tasks, preference/compatibility for team members involved, task precedence (e.g., tasks that must be completed in order to perform other tasks), long-lead time components, financial constraints, the requirements of other projects (as they affect the present project's resources), holiday schedules, overtime considerations, or other like types of considerations or factors known to those of ordinary skill in the art that may have an impact on the performance of the project or the user's perception of task prioritization. In embodiments implemented with a neural network system the task prioritization factors are used as dimensions for the neural network comparator. In such embodiments the neural network comparator may compare the task prioritization factors that a first task has in common with a second task, possibly weighting them to accommodate the importance of the task prioritization factors. Once the task prioritization factors have been updated in 521 the method proceeds to 523 to update the task order kept by the project management task prioritization system, e.g., the task list provided on the user's GUT interface for the system. The method then proceeds from 523 to 525.

In 525 it is determined whether there are any other prioritization adjustments to be made. Since a user may make changes to the task order throughout the duration of the project, it may not be known whether there are any further prioritization adjustments until the project has completed—or at least until all the user's tasks are done. If there are further adjustments the method proceeds from 525 back to 511 along the “YES” branch. However, if it is determined in 525 that there are to be no further prioritization adjustments, the method proceeds from 525 to 527 and ends.

FIG. 6 depicts an exemplary computer network 600 and a block diagram of an information handling system 609 suitable for implementing various embodiments of a project management task prioritization system. Companies often interconnect the various computers of their operation via a LAN or other such network so that the employees can access computer applications and information for business communications. FIG. 6 depicts a wireless LAN 601 connecting desktop computer 603-605, laptop computer 607, and the computer represented by block diagram 609. Other devices such as a wireless handset 635 (e.g., a cellular telephone), a personal digital assistant (PDA) 633, or other such communication devices may be in communication with the computer network 600 either directly (e.g., via the wireless LAN 601) or by way of the Internet 650 or another network such as the public switched telephone network (PSTN) or a wireless network 651. The computers 603-609, the wireless LAN 601, the wireless handset 635 and PDA 633 are shown as examples in order to illustrate and explain an exemplary information handling system suitable for practicing the various embodiments. In practice, a company may have many dozens—or even hundreds—of computers or information handling devices interconnected using one or more wired or wireless networks or other communications links. In some instances, a company may employ stand-alone computers not interconnected by any sort of network or links, or a combination of networked computers and stand-alone computers. Generally, however, most modern businesses facilitate communication between the computers of their employees by using a network to interconnect them. The network is also often used to provide access to the Internet 650 so that the employees may communicate and exchange information with the outside world, for example, via email.

Typically, a computer system such as the computer system 609 includes a processor 611 which may be embodied as a microprocessor or central processing unit (CPU). The processor 611 is typically configured to access an internal memory 613 via a bus such as the system bus 631. The internal memory 613 may include one or more of random access memory (RAM), read-only memory (ROM), cache memory, or a combination of these or other like types of circuitry configured to store information in a retrievable format. In some implementations the internal memory 613 may be configured as part of the processor 611, or alternatively, may be configured separate from it but within the same packaging. The processor 611 may be able to access internal memory 613 via a different bus, or via control lines (e.g., local bus 615) than it uses access the other components of computer system 609.

The computer system 609 also typically includes, or has access to, one or more storage drives 617 (or other types of storage memory) and floppy disk drives 619. The storage drive 617 is often a hard disk drive configured for the storage and retrieval of data, computer programs or other information. The storage drive 617 need not necessary be contained within the computer system 609. For example, in some embodiments the storage drive 617 may be server storage space within a network or the Internet that is accessible to the computer system 609 for the storage and retrieval of data, computer programs or other information. For example, the computer system 609 may use storage space at a server storage farm accessible by the Internet 650 or other communications lines. The floppy disk drives 619 may include a combination of several disc drives of various formats that can read and/or write to removable storage media (e.g., CD-R, CD-RW, DVD, DVD-R, floppy disk, etc.). The computer system 609 may either include the storage drives 617 and floppy disk drives 619 as part of its architecture (e.g., within the same cabinet or enclosure and/or using the same power supply), as connected peripherals, or may access the storage drives 617 and floppy disk drives 619 over a network, or a combination of these. The storage drive 617 is often used to store the software, instructions and programs executed by the computer system 609, including for example, all or parts of the computer application program for project management task prioritization.

The computer system 609 may include communication interfaces 621 configured to be communicatively connected to the Internet, a local area network (LAN), a wide area network (WAN), or connect with other devices using protocols such as the Universal Serial Bus (USB), the High Performance Serial Bus IEEE-1394 and/or the high speed serial port (RS-232). The various computers 603-609 may be connected to the Internet via the wireless router 601 (or a wired router or other node—not show) rather than have a direct connected to the Internet. The components of computer system 609 may be interconnected by a bus 631 and/or may include expansion slots conforming to any of various industry standards such as PCI (Peripheral Component Interconnect), ISA (Industry Standard Architecture), or EISA (enhanced ISA).

Typically, the computer system 609 includes one or more user input/output devices such as a keyboard and/or mouse 623, or other means of controlling the cursor (e.g., touchscreen, touchpad, joystick, trackball, etc.) represented by the user input devices 625. A display 627 is also generally included as part of the computer system 609. The display may be any of several types of displays, including a liquid crystal display (LCD), a cathode ray tube (CRT) monitor, a thin film transistor (TFT) array, or other type of display suitable for displaying information for the user. The display 627 may include one or more light emitting diode (LED) indicator lights, or other such display devices. In addition, most computer systems 609 also include, or are connected to, one or more speakers and microphones 629 for audio output and input. Speech recognition software may be used in conjunction with the microphones 629 to receive and interpret user speech commands.

For illustrative purposes, the discussion in this disclosure refers to projects being performed by a company, with employees of the company working on the tasks. In practice, any type of organization may perform a project, and the people performing the task may not necessarily be employees. Examples of some of the types of groups that may perform a project include: non-profit organizations, divisions of the military, church groups, or any association of people involved in a project or other endeavor requiring tasks to be performed by team members.

Various activities may be included or excluded as described above, or performed in a different order than shown in the figures, and still remain within the scope of at least one exemplary embodiment. For example, in some implementations blocks 503-505 which involve getting inputs from different parts of the company may possibly be omitted so that the initial order of tasks is created without such inputs. In such an implementation the flowchart of FIG. 5 would be reconfigured to proceed directly from 501 to 507. It is understood that the scope of the present invention encompasses other such block diagram omissions, additions, or changes to the flow chart and figures.

The invention may be implemented with any sort of processing units, processors and controllers (e.g., processor 611 of FIG. 6) capable of performing the stated functions and activities. For example, the processor 611 (or other processors used to implement the embodiments) may be a microprocessor, microcontroller, DSP, RISC processor, or any other type of processor that one of ordinary skill would recognize as being capable of performing the functions or activities described herein. A processing unit in accordance with at least one exemplary embodiment can operate computer software programs stored (embodied) on a computer-readable medium such as the internal memory 613, the storage drive 617, or other type of machine-readable medium, including for example, floppy disks, optical disks, a hard disk, CD, flash memory, ram, or other type of machine readable medium as recognized by those of ordinary skill in the art. The computer software programs can aid in the performance of, or perform, the various steps and activities described above. For example computer programs in accordance with at least one exemplary embodiment may include: source code for providing an initial order of the tasks in the project in graphical format to the user; source code for receiving inputs from the user to change the order of the tasks (e.g., dragging and dropping one task ahead of another); source code for developing a determination of a relative priority of the tasks that have been affected by the user's adjustments to the initial task order; source code for using a neural network comparator to determine the relative priority of the first and second tasks; source code for updating the prioritization factors for the first and second tasks; and source code for the other activities illustrated in the figures or otherwise described herein.

The use of the word “exemplary” in this disclosure is intended to mean that the embodiments or element so described serve as examples, instances, or illustrations, and are not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A method of determining prioritization factors for tasks in a project comprising at least a first task and a second task, the method comprising:
providing an initial order for performing the tasks in the project, the initial order specifying the first task being performed ahead of the second task;
receiving inputs to change the order for performing the tasks to move the second task ahead of the first task;
determining a relative priority of the first and second tasks based on said inputs; and
updating the prioritization factors for the first and second tasks.

2. The method according to claim 1, wherein the providing of the initial order comprises:
displaying a first graphical object representing the first task and a second graphical object representing the second task.

3. The method according to claim 2, wherein the receiving of the inputs comprises:
receiving user inputs to drag and drop the second object ahead of the first object.

4. The method according to claim 1, wherein the relative priority of the first and second tasks is determined using the prioritization factors in common to both the first task and the second task.

5. The method according to claim 1, further comprising:
using a comparator to determine the relative priority of the first and second tasks.

6. The method according to claim 5, wherein the prioritization factors are dimensions in a neural network system, and the comparator is a neural network comparator.

7. The method according to claim 6, further comprising:
receiving inputs to change the order for performing the tasks to move a third task ahead of the first and second tasks;
wherein one learning cycle is used for the neural network comparator to determine the relative priority of the third task to the first task and another learning cycle is used to determine the relative priority of the third task to the second task.

8. A software product comprising a machine readable medium including a program of instructions for determining prioritization factors for tasks in a project comprising at least a first task and a second task, wherein the program of instructions upon being executed on a device causes the device to perform activities comprising:
providing an initial order for performing the tasks in the project, the initial order specifying the first task being performed ahead of the second task;
receiving inputs to change the order for performing the tasks to move the second task ahead of the first task;
determining a relative priority of the first and second tasks based on said inputs; and
updating the prioritization factors for the first and second tasks.

9. The software product according to claim 8, wherein the providing of the initial order comprises:
displaying a first graphical object representing the first task and a second graphical object representing the second task.

10. The software product according to claim 9, wherein the receiving inputs to change the task order further causes the device to perform activities comprising:
receiving user inputs to drag and drop the second object ahead of the first object.

11. The software product according to claim 8, wherein the relative priority of the first and second tasks is determined using the prioritization factors in common to both the first task and the second task.

12. The software product according to claim 8, further causing the device to perform activities comprising:
using a comparator to determine the relative priority of the first and second tasks.

13. The software product according to claim 12, wherein the prioritization factors are dimensions in a neural network system, and the comparator is a neural network comparator.

14. The software product according to claim 13, further causing the device to perform activities comprising:
receiving inputs to change the order for performing the tasks to move a third task ahead of the first and second tasks;
wherein one teaming cycle is used for the neural network comparator to determine the relative priority of the third task to the first task and another learning cycle is used to determine the relative priority of the third task to the second task.

15. A system configured to determine prioritization factors for tasks in a project comprising at least a first task and a second task, the system comprising:
an electronically readable storage medium configured to store an initial order for performing the tasks in the project, the initial order specifying the first task being performed ahead of the second task;
a display device configured to display the initial order of the tasks in the project;
means for receiving inputs to change the order for performing the tasks to move the second task ahead of the first task;
a processor configured to execute instructions to determine a relative priority of the first and second tasks based on said inputs, the processor further being configured to update the prioritization factors for the first and second tasks.

16. The system according to claim 15, wherein the display device is further configured to display a first graphical object representing the first task and a second graphical object representing the second task.

17. The system according to claim 16, wherein the means for receiving inputs is further configured to:
receive user inputs to drag and drop the second object ahead of the first object.

18. The system according to claim 15, further comprising:
a comparator to determine the relative priority of the first and second tasks.

19. The system according to claim 18, further comprising:
a neural network system comprising the comparator, wherein the prioritization factors are dimensions in the neural network system.
